(19) United States
(12) Patent Application Publication
(10) Pub. No.: US 2019/0001854 A1
(43) Pub. Date: Jan. 3, 2019

(54) VEHICLE HANGING STORAGE HOOK

(71) Applicant: Charles S. Gunn, Lady Lake, FL (US)

(72) Inventor: Charles S. Gunn, Lady Lake, FL (US)

(21) Appl. No.: 16/022,905

(22) Filed: Jun. 29, 2018

Related U.S. Application Data
(60) Provisional application No. 62/526,694, filed on Jun. 29, 2017.

(51) Int. Cl. B60N 2/90; B60R 7/04; B60R 7/10

(52) U.S. Cl. CPC B60N 2/90; B60N 2002/905; B60R 7/10; B60R 7/043

(57) ABSTRACT

A storage hook. The storage hook includes a body. The body includes at least one slot formed therethrough. A U-shaped hook is joined to and extends from a periphery of the body. The slot is sized to receive at least one head rest support bar therethrough. The storage hook is thereby configured to be disposed in between a headrest and a vehicle seat. The U-shaped hook protrudes outward, thereby providing an additional hook within the vehicle.

### CROSS-REFERENCE TO RELATED APPLICATION

This application claims the benefit of priority of U.S. provisional application No. 62/526,694, filed Jun. 29, 2017, the contents of which are herein incorporated by reference.

### BACKGROUND OF THE INVENTION

The present invention relates to hooks and holders for the inside of vehicles and, more particularly, to a hook or holder to retain items between the seating of a vehicle so that drivers and passengers have easy access.

Hanging handbags, grocery bags, hats and the like inside a vehicle is desirable. Currently, there are different types of hooks and holders that restrain items behind vehicle seating, which makes them difficult or inaccessible to the driver or passenger. None of the current hooks and holders retain items between the seating.

As can be seen, there is a need for a hook or holder to retain items between the seating of a vehicle so that drivers and passengers have easy access.

### SUMMARY OF THE INVENTION

In one aspect of the present invention, a vehicle hanging storage hook comprises: a body comprising at least one slot formed therethrough; and a U-shaped hook joined to and extending from a periphery of the body, wherein the at least one slot is sized to receive at least one head rest support bar therethrough.

In another aspect of the present invention, a method of adding a storage hook to an interior of a vehicle comprises steps of: providing a vehicle hanging storage hook comprising: a body comprising at least one slot formed therethrough; and a U-shaped hook joined to and extending from a periphery of the body; securing the vehicle hanging storage hook in between a headrest and a seat by placing at least one head rest support bar of the headrest within the at least one slot.

These and other features, aspects and advantages of the present invention will become better understood with reference to the following drawings, description and claims.

### BRIEF DESCRIPTION OF THE DRAWINGS

FIG. 1 is a perspective detail view of an embodiment of the present invention shown in use;

FIG. 2 is a perspective view of an embodiment of the present invention;

FIG. 3 is an exploded view of an embodiment of the present invention;

FIG. 4 is a section detail view of the present invention taken along line 4-4 in FIG. 2;

FIG. 5 is a section detail view of the present invention taken along line 5-5 in FIG. 2;

FIG. 6 is a section detail view of an embodiment of the present invention;

FIG. 7 is a perspective view of an embodiment of the present invention illustrating attachment to a headrest;

FIG. 8 is a perspective view of an embodiment of the present invention illustrating attachment to a headrest;

FIG. 9 is a perspective view of an embodiment of the present invention illustrating attachment to a headrest;

FIG. 10 is a perspective view of an embodiment of the present invention;

FIG. 11 is a perspective view of an embodiment of the present invention shown in use;

FIG. 12 is a perspective view of an embodiment of the present invention illustrating attachment to a headrest;

FIG. 13 is a section view of the present invention taken along line 13-13 in FIG. 10; and

FIG. 14 is a section view of the present invention taken along line 14-14 in FIG. 10.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

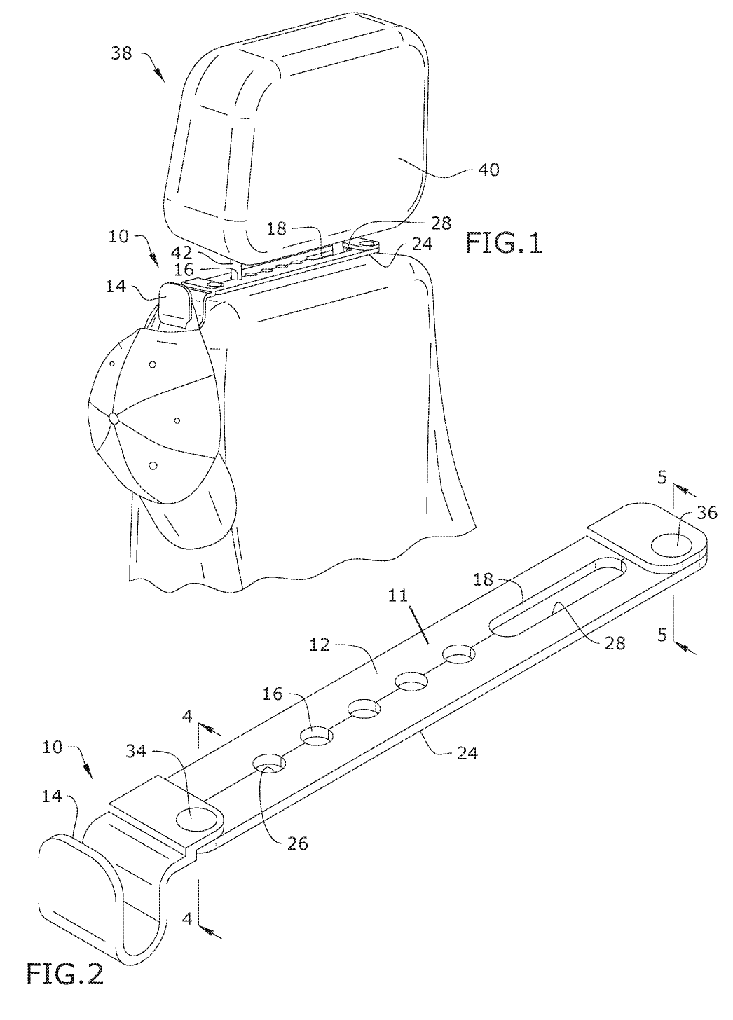

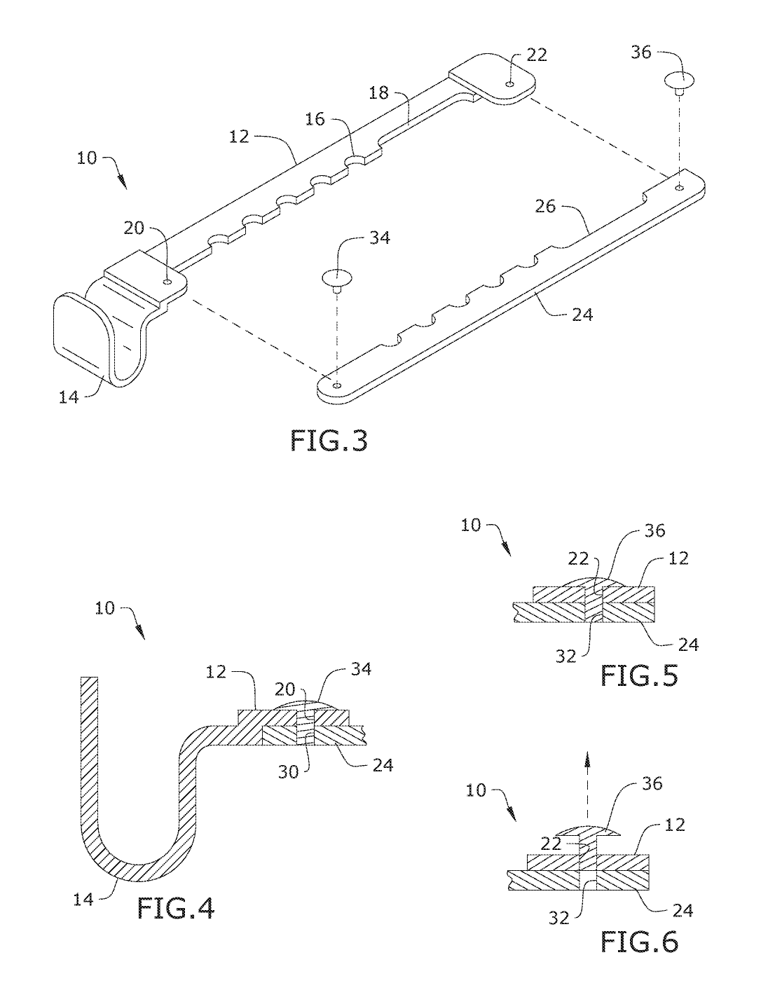

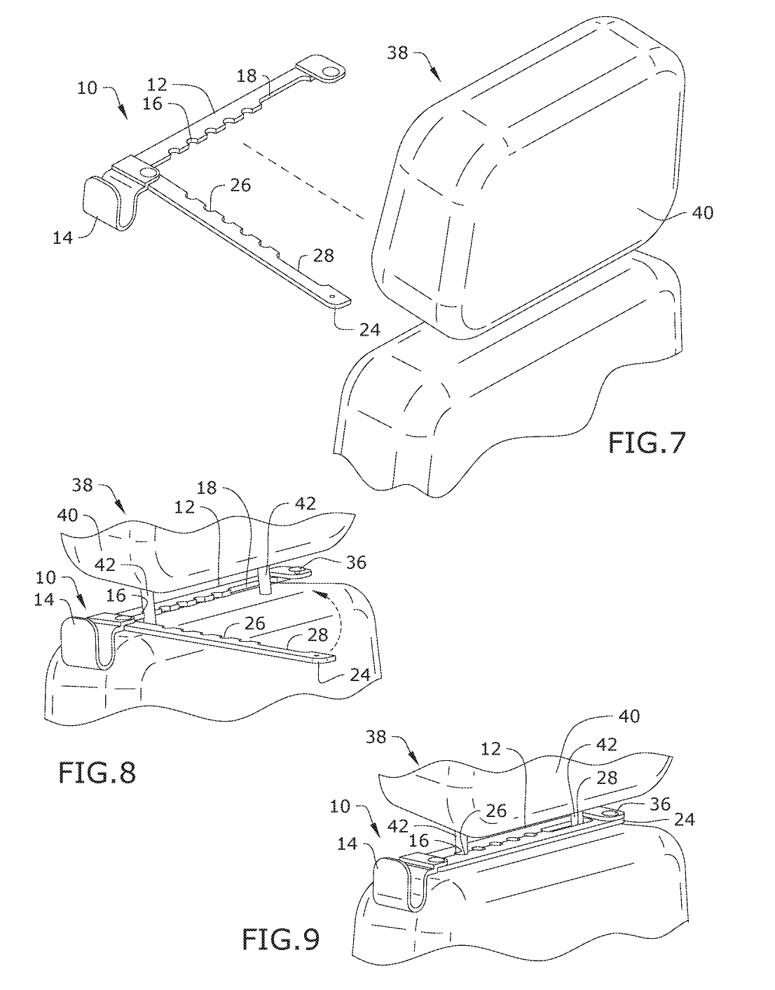

Referring to FIGS. 1 through 14, the present invention includes a storage hook 10, 46. The storage hook 10, 46 includes a body 11, 47. The body 11, 47 includes at least one slot 18, 48, 50 formed therethrough. A U-shaped hook 14, 56 is joined to and extends from a periphery of the body 11, 47. The slot 18, 48, 50 is sized to receive at least one head rest support bar 42 therethrough. The storage hook 10, 46 is thereby configured to be disposed in between a headrest 40 and a vehicle seat 38. The U-shaped hook 14, 56 protrudes outward, thereby providing an additional hook within the vehicle.

FIGS. 1 through 9 illustrate a first embodiment of the storage hook 10. The body 11 includes a first end opposite a second end, a first side edge, and a second side edge opposite the first side edge. The U-shaped hook 14 may protrude from one of the first end and the second end. The body 11 may include a first arm 12 and a second arm 24. The first arm 12 includes a pivot hole 20 that aligns with a pivot hole 30 of the second arm 24 at the first end. The first arm 12 further includes a lock hole 22 that aligns with a lock hole 32 of the second arm 24 at the second end. A pivot pin 34 fits within the aligned pivot holes 20, 30, allowing the second arm 24 to pivot about a longitudinal axis of the pivot pin 34 relative to the first arm 12. A lock pin 36 fits within the aligned lock holes 22, 32, locking the second ends together and preventing the second arm 24 from pivoting relative to the first arm.

In certain embodiments, an inner edge of the first arm 12 may include a plurality of semi-circular notches 16 that correspond with a plurality of semi-circular notches 26 of an inner edge of the second arm 24. Further, the inner edge of the first arm 12 may also include an elongated slot 18 that corresponds with an elongated slot 28 of the inner edge of the second arm 24. The elongated slots 18, 28 and the corresponding notches 16, 26 allows the present invention to be used with different sized headrests 40 as well as allowing the user to adjust how far the U-shaped hook 14 protrudes from the seat 38.

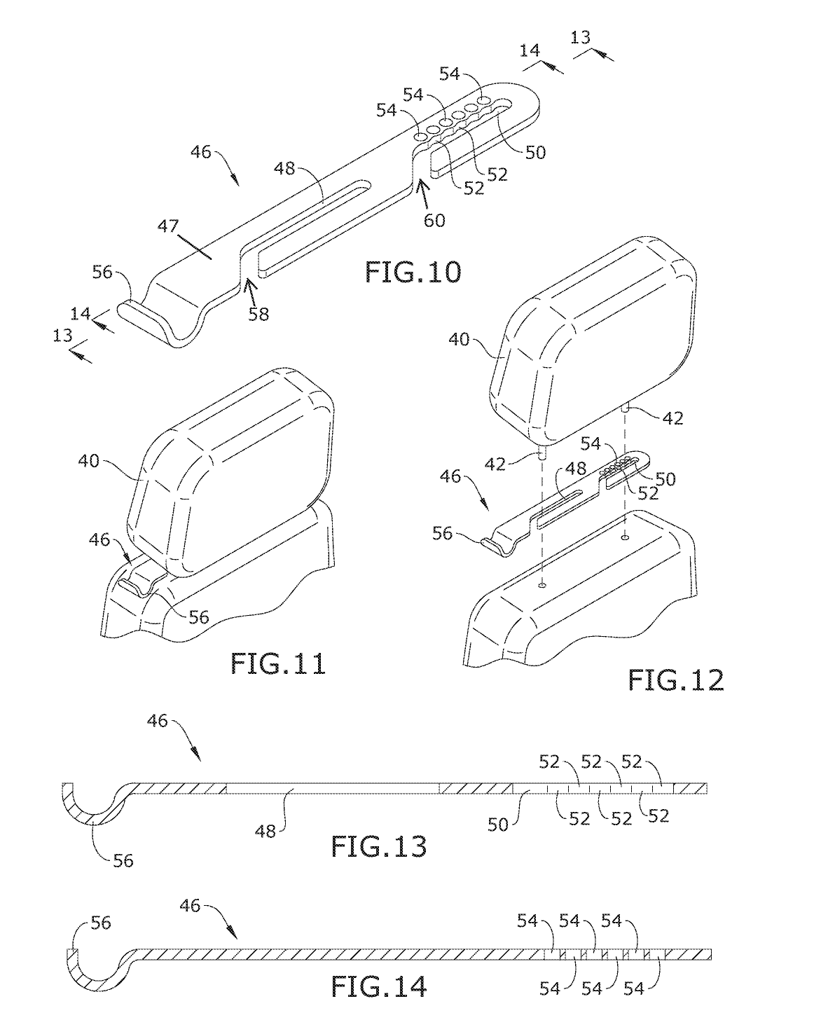

FIGS. 10 through 14 include a second embodiment of the storage hook 46. The body 47 includes is an elongated body having a planar upper and lower surface. The body 47 further includes a first end opposite a second end, a first side edge, and a second side edge opposite the first side edge. The body 47 may be an elongated body 47. The first side edge and the second side edge are disposed along the length of the elongated body 47. The U-shape hook 56 is extending from at least one of the first end and the second end. The at least one slot 48, 50 includes a first elongated slot 48 and a second elongated slot 50 aligned with one another along a length of the elongated body 47 and spaced apart. The first and second elongated slots 48, 50 allows the present invention to be used with different sized headrests 40 as well as allowing the user to adjust how far the U-shaped hook 56 protrudes from the seat 38.

In certain embodiments, the present invention includes a first entrance slot 58 formed at the first side edge and extending to the first elongated slot 48, and a second entrance slot 60 formed at the first side edge and extending to the second elongated slot 50. The first entrance slot 58 and the second entrance slot 60 are substantially parallel to one another. For example, the first entrance slot 58 and the second entrance slot 60 are at an acute angle relative to the first side edge. The entrance slots 58, 60 allow the present invention to be secured to the head rest support bars 42 without having to remove the headrest 40 from the seat 38.

In certain embodiments, the elongated body 47 may further include semicircular notches 52 defined on an inner edge of the second elongated slot 50. The semicircular notches 52 may prevent the elongated body 47 from shifting while attached to the headrest 40. In certain embodiments, the elongated body 47 further includes a plurality of openings 54 that are aligned with one another and disposed adjacent to the second elongated slot 50. The head rest bar 42 may be inserted into one of the plurality of openings 54 instead of the second elongated slot 50 to further prevent the elongated body 47 from shifting while attached to the headrest 40.

A method of adding a storage hook to an interior of a vehicle may include the following steps. Provide the vehicle hanging storage hook 10, 46 described above. Secure the vehicle hanging storage hook 10, 46 in between the headrest 40 and the seat 38 by placing at least one head rest support bar 42 of the headrest 40 within the at least one slot 18, 48, 50.

It should be understood, of course, that the foregoing relates to exemplary embodiments of the invention and that modifications may be made without departing from the spirit and scope of the invention as set forth in the following claims.

What is claimed is:

1. A vehicle hanging storage hook comprising:
a body comprising at least one slot formed therethrough; and
a U-shaped hook joined to and extending from a periphery of the body, wherein
the at least one slot is sized to receive at least one head rest support bar therethrough.

2. The vehicle hanging storage hook of claim 1, wherein the body is an elongated body and the at least one slot comprises a first elongated slot and a second elongated slot aligned with one another along a length of the elongated body and spaced apart.

3. The vehicle hanging storage hook of claim 2, wherein the periphery of the elongated body comprises a first side edge, a second side edge opposite the first side edge, a first end, and a second end opposite the first end, wherein the first side edge and the second side edge are disposed along the length of the elongated body.

4. The vehicle hanging storage hook of claim 3, further comprising a first entrance slot formed at the first side edge and extending to the first elongated slot, and a second entrance slot formed at the first side edge and extending to the second elongated slot, wherein the first entrance slot and the second entrance slot are substantially parallel to one another.

5. The vehicle hanging storage hook of claim 4, wherein the first entrance slot and the second entrance slot are at an acute angle relative to the first side edge.

6. The vehicle hanging storage hook of claim 2, wherein the elongated body further comprises semicircular notches defined on an inner edge of the second elongated slot.

7. The vehicle hanging storage hook of claim 6, further comprising a plurality of openings aligned with one another and disposed adjacent to the second elongated slot.

8. The vehicle hanging storage hook of claim 3, wherein the U-shape hook is extending from at least one of the first end and the second end.

9. A method of adding a storage hook to an interior of a vehicle comprising steps of:
providing a vehicle hanging storage hook comprising:
a body comprising at least one slot formed therethrough; and
a U-shaped hook joined to and extending from a periphery of the elongated body;
securing the vehicle hanging storage hook in between a headrest and a seat by placing at least one head rest support bar of the headrest within the at least one slot.

10. The method of claim 9, wherein the body is an elongated body and the at least one slot comprises a first elongated slot and a second elongated slot aligned with one another and spaced apart.

11. The method of claim 10, further comprising the step of placing a first head rest support bar within the first elongated slot and placing a second head rest support bar within the second elongated slot.

12. The method of claim 10, wherein the elongated body further comprises semicircular notches defined on an inner edge of the second elongated slot.
